(19) United States
(12) Patent Application Publication
(10) Pub. No.: US 2009/0269653 A1
(43) Pub. Date: Oct. 29, 2009

(54) FUEL CELL

(75) Inventors: Akira Yajima, Tokyo (JP); Yumiko Takizawa, Yokohama-shi (JP); Asako Satoh, Yokohama-shi (JP); Hirofumi Kan, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, TOKYO (JP)

(21) Appl. No.: 11/909,817

(22) PCT Filed: Mar. 28, 2006
(86) PCT No.: PCT/JP2006/306236

§ 371 Date: Sep. 27, 2007

(30) Foreign Application Priority Data
Mar. 28, 2005 (JP) 2005-092778

(51) Int. Cl. H01M 4/00

(52) U.S. Cl. 429/40

(57) ABSTRACT

A fuel cell comprising a cathode catalyst layer (2) containing a cathode catalyst particle and a proton conductive resin, an anode catalyst layer (3) and a proton conductive membrane (6) provided between the cathode catalyst layer (2) and the anode catalyst layer (3), wherein a content of the cathode catalyst particle in the cathode catalyst layer (2) is substantially the same on a first surface facing the proton conductive membrane (6) and on a second surface opposite to the first surface, and a content of the proton conductive resin in the cathode catalyst layer (2) is increased with an increase in distance from the second surface toward the first surface.

### TECHNICAL FIELD

The present invention relates to a fuel cell using liquid fuel or gasified fuel obtained by gasifying liquid fuel as the fuel to be supplied to an anode catalyst layer.

### BACKGROUND ART

In recent years, various electronic devices such as personal computers and cellular telephones have become compact as a result of developments in semiconductor technologies, and attempts are being made to use fuel cells in these compact devices. Fuel cells have an advantage that to generate electricity merely requires the supply of fuel and an oxidizer, and continuous electricity generation merely requires the fuel to be replenished. Therefore, they are very advantageous systems to power portable electronic devices if they can be compact. In particular, direct methanol fuel cells (DMFCs) use methanol having a high energy density as fuel and can draw current directly from methanol on an electrode catalyst. These cells, therefore, need no reformer and can be compact. Also, the handling of fuel in DMFCs is easier than it is for hydrogen gas fuel and therefore, DMFCs are promising power sources for compact devices.

As to a method of supplying fuel for DMFCs, there are known: gas-supply-type DMFCs in which liquid fuel is gasified and the gasified fuel is fed to the fuel cell by a blower; liquid-supply-type DMFCs in which liquid fuel is fed to a fuel cell by a pump; and internal-gasifying-type DMFCs in which liquid fuel is gasified in a cell to supply the fuel to an anode as disclosed in Japanese Patent No. 3413111.

There are various configurations of a fuel cell according to the type of fuel and supplying method. A proton conductive resin membrane is used as electrolyte in a fuel cell used for a power source in, primarily, small devices regardless of the type of fuel and supplying method. This fuel cell may have a structure in which a cathode catalyst layer is disposed on one surface of this proton conductive membrane, an anode catalyst layer is disposed on the other surface thereof, a cathode gas-diffusing layer is laminated on the cathode catalyst layer and an anode gas-diffusing layer is laminated on the anode catalyst layer. The cathode gas-diffusing layer serves to supply oxidizing gas uniformly to the cathode catalyst layer and the anode gas-diffusing layer serves to supply fuel uniformly to the anode catalyst layer. Examples of the cathode catalyst layer may include a porous layer including a cathode catalyst particle and a proton conductive resin, and a porous layer including an anode catalyst particle and a proton conductive resin may be used as the anode catalyst layer.

It is required for this fuel cell to output high power even in the case where air is supplied at an extremely low flow rate like the case where air is not forcibly supplied to the cathode by a pump but is naturally introduced from an opening provided in the cell to be supplied to the cathode.

Jpn. Pat. Appln. KOKAI Publication No. 2002-117862 relates to a fuel cell in which air is forcibly flowed through a channel of a separator to be supplied to the cathode. This publication discloses that slurries different in the content of a proton conductive resin are applied two or more times to allow the concentration of the proton conductive resin to be increased gradually from the outside towards the interface between a cathode catalyst layer and a solid polymer membrane, to thereby improve the ion conductivity of the catalyst layer.

According to Jpn. Pat. Appln. KOKAI Publication No. 2002-117862, the catalyst layer is formed by applying a slurry as mentioned above. It is therefore required to secure a solvent in a necessary content by decreasing the content of the cathode catalyst particles as much as the content of the proton conductive resin in the slurry is increased, to keep the viscosity of the slurry in a state appropriate to coating. Therefore, in the cathode catalyst layer described in Jpn. Pat. Appln. KOKAI Publication No. 2002-117862, the amount of the cathode catalyst particles is decreased with an increase in distance from the outside to the interface though the amount of the proton conductive resin is increased with an increase in distance from the outside to the interface. There is therefore a problem that activation polarization is increased and the output power of the fuel cell cannot be improved.

### DISCLOSURE OF INVENTION

It is an object of the present invention to provide a fuel cell by which high output performance can be obtained even when air is supplied at a low flow rate.

According to an aspect of the present invention, there is provided a fuel cell comprising:

a cathode catalyst layer containing a cathode catalyst particle and a proton conductive resin;

an anode catalyst layer; and

a proton conductive membrane provided between the cathode catalyst layer and the anode catalyst layer,

wherein a content of the cathode catalyst particle in the cathode catalyst layer is substantially the same on a first surface facing the proton conductive membrane and on a second surface opposite to the first surface, and

a content of the proton conductive resin in the cathode catalyst layer is increased with an increase in distance from the second surface toward the first surface.

### BRIEF DESCRIPTION OF DRAWINGS

FIG. 1 is a typical sectional view showing a direct methanol fuel cell according to one embodiment of the present invention.

FIG. 2 is a typical view showing an MEA of a direct methanol fuel cell of FIG. 1.

FIG. 3 is a characteristic curve showing the relationship between a distance of a cathode catalyst layer in the direction of thickness and a content of fluorine F) in the cathode catalyst layer in the direct methanol fuel cell of Example 1.

FIG. 4 is a characteristic curve showing the relationship between the distance of the cathode catalyst layer in the direction of thickness and a content of platinum (Pt) in the cathode catalyst layer in the direct methanol fuel cell of Example 1 of the present invention.

FIG. 5 is a curve showing the relationship between load current density and cell voltage in each fuel cell of Examples 1 and 2 and Comparative Examples.

FIG. 6 is a curve showing a change in output density with time in each fuel cell of Examples 1 and 2 and Comparative Examples.

### BEST MODE FOR CARRYING OUT THE INVENTION

A fuel cell according to the present invention is provided with a cathode catalyst layer containing cathode catalyst particles and a proton conductive resin, an anode catalyst layer containing anode catalyst particles and a proton conductive resin, and a proton conductive membrane disposed between the cathode catalyst layer and the anode catalyst layer. It is desired that a cathode gas-diffusing layer be laminated on the cathode catalyst layer and an anode gas-diffusing layer be laminated on the anode catalyst layer. The cathode gas-diffusing layer serves to diffuse an oxidizing gas uniformly into the cathode catalyst layer and the anode gas-diffusing layer serves to diffuse fuel uniformly into the anode catalyst layer. Examples of the oxidizing gas may include gaseous materials, which are easily reduced, such as air and oxygen. While the oxidizing gas may be forcibly supplied by using an air pump, a structure in which the open air is directly introduced from an opening portion is also possible. As the fuel, an oxidizable material such as methanol may be used and also, liquid fuel such as pure methanol or an aqueous methanol solution or gasified fuels obtained by gasifying the above liquid fuels may be used. The concentration of the aqueous methanol solution is preferably made to be a high value exceeding 50 mol %. Also, the purity of pure methanol is preferably 95% by weight or more and 100% by weight or less. This results in realization of a fuel cell having a high energy density and high output performance. In this case, the liquid fuel is not always limited to methanol fuel but may be ethanol fuel such as an aqueous ethanol solution and pure ethanol, propanol fuel such as an aqueous propanol solution and pure propanol, glycol fuel such as an aqueous glycol solution and pure glycol, dimethyl ether, formic acid or other liquid fuel. In any case, liquid fuel corresponding to a fuel cell is stored.

The following is the details of explanations as to how a so-called power generation reaction occurs to produce current (flow of electrons) in a fuel cell having such a structure.

When fuel is supplied to the anode catalyst layer (also called fuel electrode catalyst layer), protons (H⁺; also called a hydrogen ion) and electrons (e⁻) are generated by an oxidation reaction of this fuel. When, for example, methanol is used as the fuel, the reaction occurs in the anode catalyst layer is given by the following formula (1).

CH₃OH+H₂O→CO₂+6H⁺+6e⁻ (1)

The protons generated in the anode catalyst layer are diffused into the cathode catalyst layer (also called an air electrode catalyst layer) through the proton conductive membrane. Also, at the same time, the electrons generated in the anode catalyst layer flow through an external circuit connected to the fuel cell, energize the load (resistor) of the external circuit and flow into the cathode catalyst layer.

Oxidizing gas is supplied to the cathode catalyst layer from the cathode gas-diffusing layer and enters into a reducing reaction with the protons diffused through the proton conductive membrane and the electrons flowing through the external circuit, to produce reaction products. When, for example, air is supplied to the cathode catalyst layer as the oxidizing gas, the reaction of oxygen in the air occurs in the cathode catalyst layer according to the following formula (2) and in this case, the reaction product is water (H₂O).

O₂+4H⁺+4e⁻→2H₂O (2)

These reactions given by the formulae (1) and (2) occur simultaneously to complete the power generation reaction required for a fuel cell.

Here, in order to improve the output of a fuel cell, which is represented by the product of the voltage generated in the fuel cell and the current flowed from the fuel cell, it is necessary to either raise the voltage obtained when electricity is generated in the fuel cell under a constant current or to raise the current when electricity is generated at a constant voltage. For this purpose, a prompt progress in both the reactions given by the above formulae (1) and (2) is important.

In consideration of the formula (2), the following three points are important for a prompt progress in the reaction.

(I) O₂, H⁺ and e⁻ must be supplied to the surface of the cathode catalyst particle, which is a reaction field, promptly and sufficiently.

(II) H₂O must be promptly removed from the surface of the cathode catalyst particle.

(III) Various elementary reactions in the surface of the cathode catalyst layer must proceed promptly. For example, a reaction of an oxygen molecule O₂ in which the bonds among oxygen atoms are uncoupled to generate active oxygen atoms must proceed promptly.

Among these three points, a drop in the voltage in a fuel cell or a reduction in current which is caused by a limitation to the moving rate or amount of a material as shown in the above (I) and (II) is generally called “diffusion polarization” or “diffusion overvoltage”. And, a drop in the voltage in a fuel cell or a reduction in current which is caused by a limitation to the rate of the reaction itself is generally called “activation polarization” or “activation overvoltage”. The above-mentioned (I) to (III) can be rephrased as “to decrease the diffusion polarization and activation polarization”.

Particularly, when air is supplied to the cathode catalyst layer at a low flow rate by, for example, introducing air naturally from an opening portion, the influence of the diffusion polarization in the cathode catalyst layer is significantly increased. This is because although H₂O is generated in the cathode catalyst layer by the reaction given by the formula (2), most of the generated H₂O presents in a liquid state since the atmosphere in the cathode catalyst layer is put into the condition of a temperature of about 80° C. or less and a pressure almost equal to atmospheric pressure, and this liquid H₂O clogs pores in the cathode catalyst layer and tends to inhibit the distribution of O₂. Namely, current is dropped resultantly because O₂ enough to cause the reaction given by the formula (2) is not supplied to the surface of the cathode catalyst particle.

Also, the following causes are also considered to be the reason why the distribution of O₂ is hindered by the generated H₂O. The cathode catalyst particles present in the cathode catalyst layer usually exist in the condition that they are carried on a carbon powder. This carbon powder is generally increased in crystallinity by, for example, being sintered at high temperatures to improve the water repellency of its surface, thereby preventing the generated liquid H₂O from being adsorbed on the particle surface. In the meantime, the proton conductive resin present in the cathode catalyst layer together with these carbon powder and cathode catalyst particles generally has a hydrophilic surface and is also of such a nature that it absorbs water and therefore swells, resulting in an increase in volume. Therefore, in the cathode catalyst layer in which a carbon powder and a proton conductive resin coexist, generated H₂O adsorbs much to a part where much proton conductive resin is present and form liquid droplets there, to clog pores. Also, at the same time, the proton conductive resin which has absorbed the H₂O swells and is increased in its volume, causing clogging of pores and a reduction in pore diameter.

In order to prevent this, it is considered that the clogging of pores is prevented even if liquid H₂O is generated, by increasing the porosity of the cathode catalyst layer. In this case, the increase in the porosity of the cathode catalyst layer implies that the cathode catalyst particles and proton conductive resin present in the cathode catalyst layer are reduced in each amount per unit volume, which gives rise to a problem from the following two reasons.

Specifically, one reason is that since the amount of the cathode catalyst particles is reduced, a field where the reaction mentioned in the above (III) occurs reduced and therefore, the activation polarization is increased.

Another reason is that since the amount of the proton conductive resin is small, the amount or rate of protons to be supplied to the surface of the cathode catalyst particle is limited, resulting in increased diffusion polarization. From these two problems, it is not always desirable to increase the porosity of the cathode catalyst layer to higher than necessary from the viewpoint of improving the output of the fuel cell.

As is mentioned in Jpn. Pat. Appln. KOKAI Publication No. 2002-117862, on the other hand, it is also considered that slurries different in the content of the proton conductive resin are applied two or more times to form the cathode catalyst layer. If at this time, a slurry containing the proton conductive resin in a larger content is used on the side closer to the proton conductive membrane and a slurry containing the proton conductive resin in a smaller content is used on the side closer to the cathode gas-diffusing layer in the cathode catalyst layer, it is possible to eliminate, among the above two problems, the problem as to the increase in diffusion polarization due to the limitation to the amount or rate of protons to be supplied to the surface of the cathode catalyst particle. This is because in the cathode catalyst layer, the protons diffused from the proton conductive membrane react with oxidizing gas supplied to the cathode catalyst layer and are further diffused to the gas-diffusing layer side while they are consumed. For this reason, the amount of the protons diffused into the cathode catalyst layer is larger on the side closer to the proton conductive membrane and smaller on the side closer to the gas-diffusing layer. Therefore, the content of the proton conductive resin on the side closer to the proton conductive membrane in the cathode catalyst layer is increased, whereby the protons can be diffused rapidly to the surface of the cathode catalyst particle. A sufficient amount of protons can be diffused promptly to the surface of the cathode catalyst particle on the side closer to the gas-diffusing layer in the cathode catalyst layer even if the content of the proton conductive resin is small.

However, if the content of the proton conductive resin in the slurry is increased, it is necessary to decrease the content of the cathode catalyst particles to maintain slurry viscosity appropriate for coating, posing the problem that the activation polarization is increased.

According to the present invention, the content of the cathode catalyst particles in the cathode catalyst layer is so designed that the content of the catalyst particles on the first surface facing the proton conductive membrane is substantially equal to that on the second surface opposite to the first surface, and also, the content of the proton conductive resin in the cathode catalyst layer is increased with an increase in distance from the second surface toward the first surface, making it possible to limit increases in diffusion polarization and activation polarization when air is supplied at a low flow rate. Therefore, high output performance can be obtained when air is supplied at a low flow rate.

Here, the term “substantially equal” means that as to a content C of the cathode catalyst particles in the cathode catalyst layer, a difference between a content C₁ on the surface facing the cathode gas-diffusing layer and a content C₂ on the surface facing the proton conductive membrane is smaller than a variation σ_{C} of the content C of the cathode catalyst particles in the cathode catalyst layer.

The term “increased with an increase in distance from the second surface toward the first surface” means that with regard to a content of the proton conductive resin in the cathode catalyst layer, a difference C_{2F}-C_{1F} between a content C_{1F} of the proton conductive resin on the surface facing the cathode gas-diffusing layer and a content C_{2F} of the proton conductive resin on the surface facing the proton conductive membrane is larger than a variation σ_{CF} of the content of the proton conductive resin in the cathode catalyst layer. It is to be noted that in the judgment as to whether or not “the content is increased”, the influence of a natural variation in the amount of the proton conductive resin in the cathode catalyst layer is ignored.

It is desirable that the composition at the central part of the cathode catalyst layer be substantially equal to that of the first surface of the cathode catalyst layer to secure good distribution of air in the cathode catalyst layer. For example, if a cathode catalyst layer having no proton conductive resin is manufactured in the method which will be explained later and then a highly viscous proton conductive resin solution is applied to the first surface of the obtained cathode catalyst layer, the solution is penetrated insufficiently into the second surface, making it possible to form such a state.

In the aforementioned Jpn. Pat. Appln. KOKAI Publication No. 2002-117862, it is also possible to increase the content of the proton conductive resin without decreasing the content of the cathode catalyst particles, which in turn reduces the porosity of the cathode catalyst layer and therefore the distribution of O₂ is made difficult, bringing about an increase in diffusion polarization, so that the output of the fuel cell cannot be improved.

In the cathode catalyst layer, the proton conductive resin is not added in the stage of preparing the paste but is compounded by dipping and therefore, the proton conductive resin is distributed much on the surface facing the proton conductive membrane and is reduced with an increase in the distance from the surface toward the cathode diffusion layer side. On the cathode diffusion layer side, many pores are left unremoved and therefore, the oxidizing gas can be smoothly supplied to the cathode catalyst layer, making it possible to limit an increase in diffusion polarization when the oxidizing gas is supplied at a low flow rate.

A method of producing the cathode catalyst layer will be explained hereinbelow. First, a dispersion medium such as water is added to a cathode catalyst to disperse the cathode catalyst, thereby preparing a paste. The obtained paste is applied to a cathode gas-diffusing layer to form a cathode catalyst layer including no proton conductive resin on the cathode gas-diffusing layer. The resulting product is dipped in a proton conductive resin solution to impregnate the cathode catalyst layer with the proton conductive resin and then pulled up from the solution, followed by drying. During the impregnation and drying processes, a distribution in the direction of thickness is naturally formed such that the proton conductive resin is increased on the surface of the cathode catalyst layer.

The reason why the content of the proton conductive resin is larger on the surface of the cathode catalyst layer is that the solution of the proton conductive resin has a certain viscosity, which is a cause of a certain resistance to the impregnation of the porous cathode catalyst layer with the solution. When the concentration of the proton conductive resin in the solution is low, the viscosity of the solution is low and therefore the resistance when the solution is penetrated is low, which makes it easy to penetrate the solution into the cathode catalyst layer. For this reason, as to the content of the proton conductive resin on the surface of the cathode catalyst layer in the membrane electrode assembly (MEA), a difference in the content between the surface to be in contact with the proton conductive membrane and the surface to be close to the cathode gas-diffusing layer is reduced. On the other hand, when the concentration of the proton conductive resin in the solution is high, the viscosity of the solution is high, and therefore the resistance to the penetration is large. Therefore, the difference in the content of the proton conductive resin between the surface of the cathode catalyst layer and the surface on the side close to the cathode gas-diffusing layer is increased. However, when the viscosity of the solution exceeds a certain value, a part where the proton conductive resin is not penetrated at all is generated in the cathode catalyst layer. Because no proton conductive resin exists at all in this part and such a part cannot contribute to the reaction of the cathode catalyst layer, the output of the entire fuel cell is dropped.

The adequate concentration of the proton conductive resin in the solution differs depending on the types of proton conductive resin and solvent, and the porosity and distribution of pore diameter in the cathode catalyst layer. However, when the proton conductive resin is perfluorocarbonsulfonic acid and the solvent is any one or a mixture of two or more of water, methanol, ethanol and propanol, it is preferable to use a solution containing 0.1 to 20% by weight of perfluorocarbonsulfonic acid. When the porosity or average pore diameter in the cathode catalyst layer is small, the resistance to the penetration of the solution is increased and therefore, the concentration of the solution is preferably lower. When the porosity or average pore diameter in the cathode catalyst layer is large on the contrary, the concentration of the solution is preferably higher.

The proton conductive resin is not limited to fluororesins having a sulfonic acid group such as perfluorocarbonsulfonic acid and, for example, a hydrocarbon-based resin having a sulfonic acid may be used. Among these compounds, perfluorocarbonsulfonic acid is preferable. Examples of the hydrocarbon-based resin having a sulfonic acid group may include a sulfonated polyimide resin, sulfonated polyether ether ketone and styrenesulfonic acid polymer. The number of types of proton conductive resin used in the cathode catalyst layer may be one or two or more.

Examples of the cathode catalyst may include single metals (for example, Pt, Ru, Rh, Ir, Os and Pd) of the platinum group elements and alloys containing the platinum group elements. It is preferable to use platinum or an alloy of platinum and Co, Fe, Cr or the like as the cathode catalyst, though the catalysts are not limited to these materials. Also, a supported catalyst using a conductive support such as a carbon material or unsupported catalyst may be used.

A specific shape of the cathode catalyst particle is almost determined by the shape of the carbon support, though not limited to this. Examples of the shape of the carbon support include a sphere form, block form, scaly form, and fiber form. Also, an aggregate of fibers, carbon nanotube, carbon nanohorn or fullerene may also be used as the carbon support.

Porous carbon paper may be used for the cathode gas-diffusing layer.

Examples of the catalyst (hereinafter referred to as an anode catalyst) contained in the anode catalyst layer may include single metals (for example, Pt, Ru, Rh, Ir, Os and Pd) of the platinum group elements and alloys containing the platinum group elements. As the anode catalyst, Pt—Ru having strong resistance to methanol and carbon monoxide is preferably used, without limitation to it. Also, a supported catalyst using a conductive support such as a carbon material or unsupported catalyst may be used.

Examples of the proton conductive resin to be contained in the anode catalyst layer and the anode gas-diffusing layer may include the same ones as those explained in the cathode catalyst layer. The number of types of proton conductive resin used in the anode catalyst layer may be one or two or more.

Examples of the proton conductive material constituting the proton conductive electrolyte membrane may include the same ones as those explained in the cathode catalyst layer. Also, inorganic materials (inorganic oxides) such as tungstic acid and phosphorus wolframate may be used. Also, as the proton conductive electrolyte membrane, a porous base material impregnated with the above proton conductive material may be used. The number of types of proton conductive material used in the proton conductive electrolyte membrane may be one or two or more.

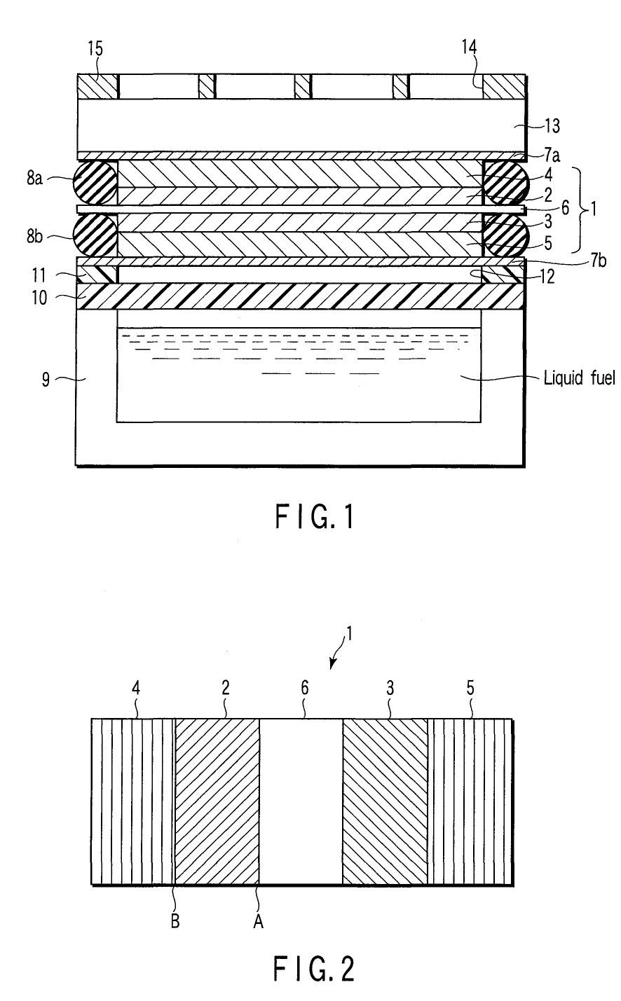

An embodiment of the fuel cell of the present invention is shown in FIGS. 1 and 2.

FIG. 1 is a typical sectional view showing a direct methanol fuel cell according to one embodiment of the present invention. FIG. 2 is a typical view showing an MEA of the direct methanol fuel cell of FIG. 1.

As shown in FIGS. 1 and 2, a membrane electrode assembly (MEA) 1 is provided with a cathode including a cathode catalyst layer 2 and a cathode gas-diffusing layer 4, an anode including an anode catalyst layer 3 and an anode gas-diffusing layer 5, and a proton conductive electrolyte membrane 6 disposed between the cathode catalyst layer 2 and the anode catalyst layer 3.

The cathode catalyst layer 2 is laminated on the cathode gas-diffusing layer 4 and the anode catalyst layer 3 is laminated on the anode gas-diffusing layer 5. The cathode gas-diffusing layer 4 serves to supply an oxidizer uniformly to the cathode catalyst layer 2 and doubles as a current collector of the cathode catalyst layer 2. On the other hand, the anode gas-diffusing layer 5 serves to supply fuel uniformly to the anode catalyst layer 3 and, at the same time, doubles as a current collector of the anode catalyst layer 3. A cathode conductive layer 7a and an anode conductive layer 7b are brought into contact with the cathode gas-diffusing layer 4 and the anode gas-diffusing layer 5, respectively. A porous layer (for example, mesh), for example, made of a metal material such as gold may be used for the cathode conductive layer 7a and the anode conductive layer 7b.

The cathode catalyst layer 2 is so designed that the content of the cathode catalyst particles on a surface (first surface) A facing the proton conductive membrane 6 is substantially equal to that on a surface (second surface) B facing the cathode gas-diffusing layer 4. Also, the content of the proton conductive resin in the cathode catalyst layer 2 is increased with an increase in distance from the second surface B toward the first surface A.

A cathode seal material 8a having a rectangular frame form is positioned between the cathode conductive layer 7a and the proton conductive electrolyte membrane 6 and also encloses the periphery of the cathode catalyst layer 2 and the cathode gas-diffusing layer 4. On the other hand, an anode seal material 8b having a rectangular frame form is positioned between the anode conductive layer 7b and the proton conductive electrolyte membrane 6 and also encloses the periphery of the anode catalyst layer 3 and the anode gas-diffusing layer 5. The cathode seal material 8a and the anode seal material 8b are O-rings that prevent leakages of the fuel and oxidizer from the membrane electrode assembly 1.

A liquid fuel tank 9 is disposed below the membrane electrode assembly 1. Liquid methanol or an aqueous methanol solution is stored in the liquid fuel tank 9. Gasified fuel supply means which supplies gasified components of the liquid fuel to the anode catalyst layer 3 is disposed above the liquid fuel tank 9. The gasified fuel supply means is provided with a gas-liquid separating membrane 10 that transmits only the gasified components of the liquid fuel and cannot transmit the liquid fuel. Here, the gasified component of liquid fuel means methanol vapor when liquid methanol is used as the liquid fuel and a mixture gas of methanol vapor and water vapor when an aqueous methanol solution is used as the liquid fuel.

A resin frame 11 is arranged between the liquid-gas separating membrane 10 and the anode conductive layer 7b. The space enclosed by the frame 11 functions as a gasified fuel receiver 12 (so-called vapor reservoir) for temporarily receiving the gasified fuel diffused through the gas-liquid separating membrane 10. It is avoidable that a large amount of gasified fuel is supplied to the anode catalyst layer 3 at a time, by the gasified fuel receiver 12 and gas-liquid separating membrane 10 which limit to the amount of methanol to be transmitted. It is therefore possible to limit the generation of methanol crossover. The frame 11 is a rectangular frame and is formed of a thermoplastic polyester resin such as PET.

In the meantime, a moisture retentive plate 13 is laminated on the cathode conductive layer 7a laminated on the membrane electrode assembly 1. A cover 15 provided with a plurality of air introduction ports 14 introducing air which is an oxidizer is laminated on the moisture retentive plate 13. Because the cover 15 also serves to apply pressure to a stack including the membrane electrode assembly 1, thereby raising the adhesion of the stack, it is formed of a metal such as SUS304. The moisture retentive plate 13 serves to limit the evaporation of water generated in the cathode catalyst layer 2 and doubles as an auxiliary diffusing layer that accelerates the uniform diffusion of the oxidizer to the cathode catalyst layer 2 by introducing the oxidizer uniformly into the cathode gas-diffusing layer 4.

According to the direct methanol fuel cell having the structure mentioned above, the liquid fuel (for example, an aqueous methanol solution) in the liquid fuel tank 9 is gasified and methanol vapor and water vapor are diffused through the gas-liquid separating membrane 10, received once in the gasified fuel receiver 12, gradually diffused through the anode gas-diffusing layer 5 from the receiver 12 and supplied to the anode catalyst layer 3, where the oxidizing reaction of methanol as shown in the above (1) occurs.

When pure methanol is used as the liquid fuel, water is not supplied from the fuel gasifying means. Therefore, for example, water generated by an oxidizing reaction of methanol mingled into the cathode catalyst layer 2 and water contained in the proton conductive membrane 6 react with methanol, causing the oxidizing reaction given by the above formula (1) or an internal reforming reaction according to a reaction mechanism using no water which is not given by the above formula (1).

The protons (H⁺) generated in these reactions diffuse through the proton conductive membrane 6 and reach the cathode catalyst layer 2. In the cathode catalyst layer 2, the proton conductive resin is distributed much on the proton conductive membrane 6 side and the diffusion of protons can be improved. Also, the distribution of the proton conductive resin is reduced as the position is closer to the cathode gas-diffusing layer 4 and therefore, the air which is introduced from the air introduction port 14 of the cover 15 and diffused through the moisture retentive plate 13, the cathode conductive layer 7a and the cathode gas-diffusing layer 4 can be diffused promptly in the cathode catalyst layer 2. Also, since the content of the cathode catalyst particles on the surface (first surface) A facing the proton conductive membrane 6 is substantially equal to that on the surface (second surface) B facing the cathode gas-diffusing layer 4, the reaction rate of the power generation reaction given by the above formula (2) can be raised. As a result, high output can be obtained also when air is naturally introduced from an air opening.

Along with the progress of the power generation reaction, water generated in the cathode catalyst layer 2 by the reaction of the above formula (2) diffuses through the cathode gas-diffusing layer 4 into the moisture retentive plate 13, where its evaporation is inhibited, so that the amount of water retained in the cathode catalyst layer 2 increases. On the other hand, the anode is put into the situation where water vapor is supplied through the gas-liquid separating membrane 10 or no water is supplied at all. As a result, along with the progress of the power generation reaction, the amount of water kept in the cathode catalyst layer 2 can be made larger than that in the anode catalyst layer 3. Therefore, the reaction in which water generated in the cathode catalyst layer 2 is transferred to the anode catalyst layer 3 through the proton conductive membrane 6 is promoted by an osmosis phenomenon, thereby promoting the methanol oxidizing reaction given by the above formula (1). Therefore, high output performance can be maintained for a long period of time.

Also, because the diffusion of water from the cathode to the anode can be promoted by the moisture retentive plate 13, it is possible to obtain high output performance also when an aqueous methanol solution having a concentration exceeding 50 mol % or pure methanol is used as the liquid fuel. Also, the liquid fuel tank can be made compact by the use of liquid fuel having a high concentration.

### EXAMPLES

Examples of the present invention will be explained in detail with reference to the drawings.

### Example 1

<Production of anode catalyst layer>

A perfluorocarbonsulfonic acid solution having a concentration of 20% by weight and used as a proton conductive resin, and water and methoxypropanol used as dispersion media were added in carbon black carrying anode catalyst particles (Pt:Ru=1:1) and the above catalyst-carrying carbon black was dispersed to prepare a paste. The resulting paste was applied to porous carbon paper as an anode gas-diffusing layer to obtain an anode catalyst layer having a thickness of 100 μm.

<Production of cathode catalyst layer>

Water was added as a dispersion medium to carbon black carrying cathode catalyst particles (Pt) to disperse the above carbon black carrying a catalyst, thereby preparing a paste. The obtained paste was applied to porous carbon paper as a cathode gas-diffusing layer to thereby obtain a 100-μm-thick cathode catalyst layer containing no proton conductive resin.

This cathode catalyst layer containing no proton conductive resin was horizontally dipped together with the cathode gas-diffusing layer in a perfluorocarbonsulfonic acid solution having a concentration of perfluorocarbonsulfonic acid of 2% by weight to impregnate with perfluorocarbonsulfonic acid used as a proton conductive resin, and then pulled up from the solution, followed by drying. The impregnation and drying processes ensure that a distribution in the direction of thickness is formed such that the proton conductive resin is more increased on the surface of the cathode catalyst layer.

In order to investigate the distributions of the proton conductive resin and cathode catalyst particles in the thus produced cathode catalyst layer, each distribution of fluorine (F) contained in perfluorocarbonsulfonic acid and platinum (Pt) contained in the cathode catalyst particles was measured.

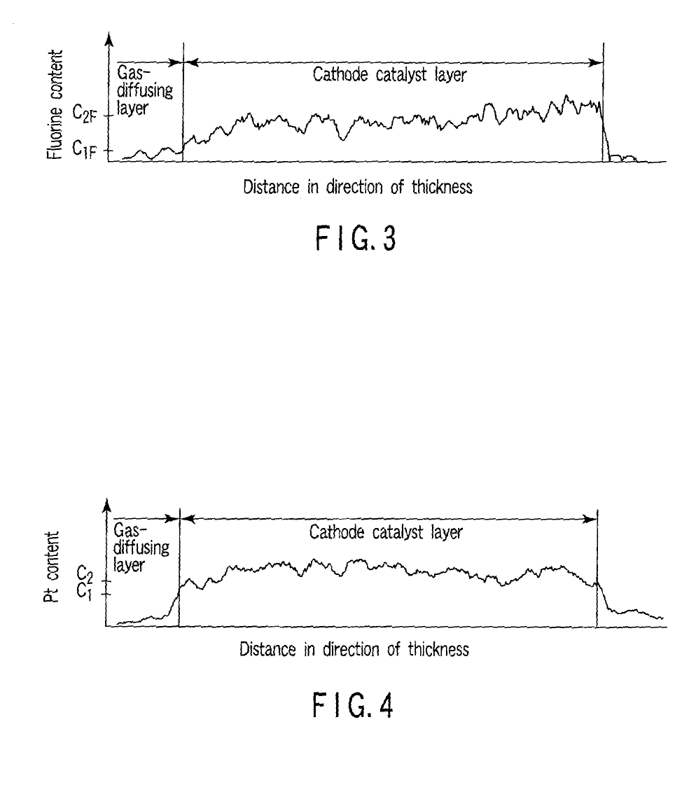

Specifically, the produced cathode catalyst layer and cathode gas-diffusing layer were cut along the direction of thickness and introduced into a sample chamber of a scanning electron microscope (trade name: ESEM-2700, manufactured by Nikon Corporation) in such a manner that the section was made to face upward. Each distribution of F and Pt on the section of the cathode catalyst layer was measured by using an energy dispersion X-ray analyzer (trade name: Genesis, manufactured by Edax) attached to the scanning electron microscope. An example of the measured distribution of F is shown in FIG. 3 and an example of the distribution of Pt measured at the same position of the cathode catalyst layer is shown in FIG. 4. In this measurement, the scanning electron microscope was used in a high vacuum mode at an acceleration voltage of 20 kV and a magnification of 800.

Each distribution of F and Pt in the cathode catalyst layer shown in FIGS. 3 and 4 does not necessarily show such a tendency that it is evenly increased and reduced as a function of the distance in the direction of thickness. The small variations in the content seen in FIGS. 3 and 4 are due to the influence of variations produced naturally in the process of producing the cathode catalyst layer. In the present invention, these variations are ignored to analyze the distributions.

Specifically, a difference C_{2F}-C_{1F} between a content C_{1F} of F on the surface of the cathode catalyst layer facing the cathode gas-diffusing layer and a content C_{2F} of F on the other surface facing the proton conductive membrane is larger than a variation σ_{CF} of the content of F in the cathode catalyst layer. It may be said from this that the content of the proton conductive resin in the cathode catalyst layer is increased with an increase in distance from the side facing the cathode gas-diffusing layer toward the side facing the proton conductive membrane.

On the other hand, a difference C₂-C₁ between a content C₁ of Pt on the surface of the cathode catalyst layer facing the cathode gas-diffusing layer and a content C₂ of Pt on the surface facing the proton conductive membrane was smaller than a variation σ_{C} of the content of Pt in the cathode catalyst layer. Therefore, in the cathode catalyst layer, the content of the catalyst particles on the side facing the cathode gas-diffusing layer is substantially equal to that on the side facing the proton conductive membrane.

<Production of membrane electrode assembly (MEA)>

A perfluorocarbonsulfonic acid membrane (trade name: Nafion Membrane, manufactured by Du Pont) having a thickness of 30 μm and a moisture content of 10 to 20% by weight was interposed as a proton conductive membrane between the anode catalyst layer and the cathode catalyst layer produced in the above manner and the resulting product was subjected to a hot press to obtain a membrane electrode assembly (MEA).

As a moisture retentive plate, a 500-μm-thick polyethylene porous film was prepared which had an air permeability of 2 sec/100 cm³ (measured by the measuring method prescribed in JIS P-8117) and a moisture permeability of 4000 g/m², 24 h (by the measuring method prescribed in JIS L-1099 A-1).

As the frame, a 25-μm-thick polyethylene terephthalate (PET) film was used. Also, as the gas-liquid separating membrane, a 200-μm-thick silicone rubber sheet was prepared.

The obtained membrane electrode assembly was combined with the moisture retentive plate, the frame, the gas-liquid separating membrane and the fuel tank to fabricate an internal-gasifying-type direct methanol fuel cell as shown in FIG. 1.

### Example 2

After a cathode catalyst layer impregnated with the proton conductive resin was produced in the same method as in Example 1, a direct methanol fuel cell was fabricated in the same method as in Example 1 except that a perfluorocarbonsulfonic acid solution was applied to the surface of the cathode catalyst layer which is to be in contact with the proton conductive membrane in MEA, and dried, to produce a cathode catalyst layer. Incidentally, the perfluorocarbonsulfonic acid solution had a higher concentration than the above perfluorocarbonsulfonic acid solution with which the cathode catalyst layer was impregnated and, for example, a concentration of 10% by weight.

When the distribution of the content of the proton conductive resin in the cathode catalyst layer was measured in the same manner as in Example 1, the content of the proton conductive resin in the cathode catalyst layer on the side facing the proton conductive membrane was more increased than that in Example 1. On the other hand, the distribution of the cathode catalyst particles was the same as that in Example 1.

### Comparative Example 1

A perfluorocarbonsulfonic acid solution having the concentration of 20% by weight and used as a proton conductive resin, and water and methoxypropanol used as dispersion media were added to carbon black carrying cathode catalyst particles (Pt) and the above catalyst-carrying carbon black was dispersed to prepare a paste. The obtained paste was applied to porous carbon paper as a cathode gas-diffusing layer to produce a 100-μm-thick cathode catalyst layer containing a proton conductive resin. The same procedures as in Example 1 were conducted except for the above process, to fabricate a direct methanol fuel cell.

In the cathode catalyst layer produced in this manner, each content of the proton conductive resin and the cathode catalyst particles was fixed regardless of distance in the direction of thickness of the cathode catalyst layer.

### Comparative Example 2

A perfluorocarbonsulfonic acid solution having the concentration of 8% by weight and used as a proton conductive resin, and water and methoxypropanol used as dispersion media in an amount of 100 parts by weight were added to 20 parts by weight of carbon black carrying cathode catalyst particles (Pt) and the above catalyst-carrying carbon black was dispersed to prepare a first paste having the low concentration of the proton conductive resin.

A perfluorocarbonsulfonic acid solution having the concentration of 20% by weight and used as a proton conductive resin, and water and methoxypropanol used as dispersion media in an amount of 100 parts by weight were added to 10 parts by weight of carbon black carrying cathode catalyst particles (Pt) and the above catalyst-carrying carbon black was dispersed to prepare a second paste having the high concentration of the proton conductive resin.

The obtained first paste having a low concentration was applied to porous carbon paper as a cathode gas-diffusing layer and then the second paste having a high concentration was applied thereto, followed by drying to produce a 100-μm-thick cathode catalyst layer containing a proton conductive resin. The same procedures as in Example 1 were conducted except for the above process, to fabricate a direct methanol fuel cell.

The distribution of the content of the proton conductive resin in the cathode catalyst layer was measured in the same manner as in Example 1, to find that the content of the proton conductive resin in the cathode catalyst layer is larger on the side facing the proton conductive membrane than on the side facing the cathode gas-diffusing layer. As to the distribution of the content of the cathode catalyst particles in the cathode catalyst layer, on the other hand, the content is smaller on the side facing the proton conductive membrane than on the side facing the cathode gas-diffusing layer.

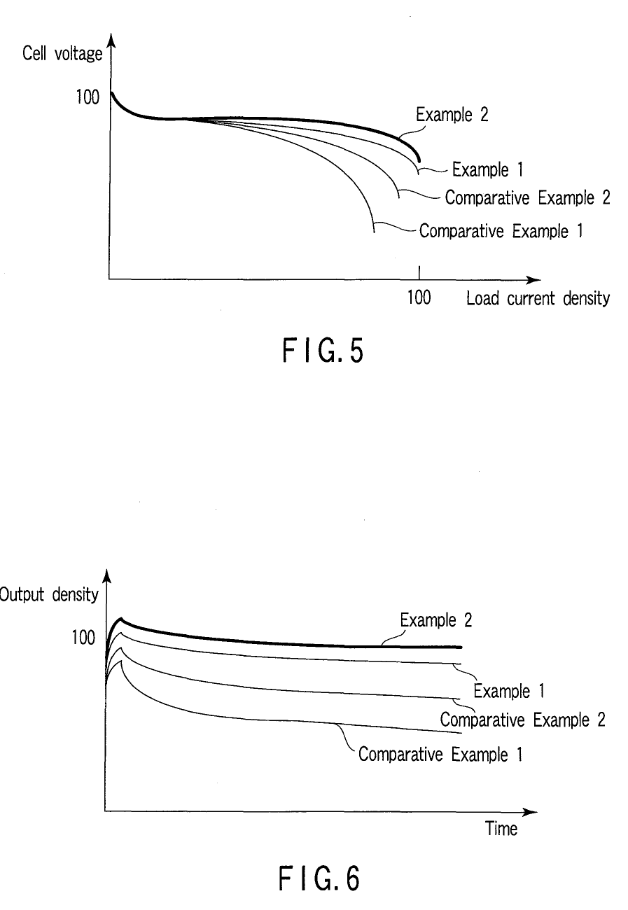

With regard to each fuel cell obtained in Examples 1 and 2 and Comparative Examples 1 and 2, pure methanol having a purity of 99.9% by weight was supplied to the fuel tank in such a manner that a methanol vapor as the fuel was supplied to the anode catalyst layer. FIG. 5 shows the relation between the cell voltage and the load current density when air was supplied to the cathode catalyst layer to generate electricity while raising load current step by step at ambient temperature. In FIG. 5, the abscissa is the load current density and the ordinate is the cell voltage. The load current density is expressed by a relative current density when the maximum load current density in Example 1 is set to 100. Also, the cell voltage is expressed by a relative cell voltage when the maximum voltage in Example 1 is set to 100.

As is clear from FIG. 4, it is understood that the fuel cells obtained in Examples 1 and 2 respectively have a larger maximum load current density than the fuel cells obtained in Comparative Examples 1 and 2, also, the cell voltage is higher in Examples 1 and 2 than in Comparative Examples when the load current density is the same, and therefore, the outputs of the fuel cells of Examples are larger in all load current densities.

When comparing Example 1 with Example 2, the maximum load current density in Example 1 is much the same as that in Example 2. However, when the same load current density is used, the cell voltage is higher in Example 2 than in Example 1 and the output of the fuel cell is higher in Example 2. The reason for this is considered to be that the maximum load current density is primarily affected by the diffusibility of O₂ in a part close to the cathode gas-diffusing layer within the cathode catalyst layer, whereas the cell voltage when the load current density is lower than the maximum load current density is primarily affected by the diffusibility of protons in a part close to the proton conductive membrane within the cathode catalyst layer. The structure of a part close to the cathode gas-diffusing layer in Example 2 is almost the same as that in Example 1. However, the amount of the proton conductive resin in a part close to the proton conductive membrane is larger in Example 2 than in Example 1, showing that Example 2 has a structure in which protons are diffused more easily. This is considered to be the reason why the results as shown in FIG. 5 were obtained.

Also, each fuel cell obtained in Examples 1 and 2 and Comparative Examples 1 and 2 was used to generate electricity at ambient temperature under a constant load and, at this time, a variation in output density, which is obtained by product of cell voltage and load current density, with time was measured. The results are shown in FIG. 6. In FIG. 6, the abscissa is the generating time and the ordinate is the output density. The output density is expressed by a relative output density when the maximum output density in Example 1 is set to 100.

As is clear from FIG. 6, it is understood that each fuel cell obtained in Examples 1 and 2 not only has a larger maximum output density but also has a smaller variation in output density with time than each cell obtained in Comparative Examples 1 and 2. The ratio of the reduction in output density with time is almost the same in Examples 1 and 2.

This is considered to be because a main cause of a reduction in output density with time is that pores of the cathode catalyst layer are clogged by H₂O generated in the cathode catalyst layer so that the distribution of O₂ is hindered and particularly, the diffusibility of O₂ in a part close to the cathode gas-diffusing layer mainly has an influence on the reduction in output density. Specifically, the content of the proton conductive resin in a part close to the cathode gas-diffusing layer is lower in each fuel cell obtained in Examples 1 and 2 than in the fuel cell obtained in Comparative Example 1 and thus the water repellency of the catalyst-carrying carbon black is predominant over the hydrophilic property of the proton conductive resin. Therefore, adsorption of liquid droplets of H₂O inside the pores and swelling of the proton conductive resin caused by absorption of water are scarcely caused and therefore the distribution of O₂ is hardly hindered. Also, in the fuel cells of Examples 1 and 2, the content of the catalyst particles in a part close to the cathode gas-diffusing layer is substantially the same as the content of the catalyst particles in a part close to the proton conductive membrane, making it possible to limit an increase in activation polarization caused by a hindrance to the distribution of O₂. It is considered that the results as shown in FIG. 6 were obtained by these reasons.

### Comparative Example 3

<Production of cathode catalyst layer>

Water was added as a dispersion medium to carbon black carrying cathode catalyst particles (Pt) and the catalyst-carrying carbon black was dispersed to prepare a paste. The obtained paste was applied to a base material to obtain a 100-μm-thick cathode catalyst layer containing no proton conductive resin.

This cathode catalyst layer with the base material containing no proton conductive resin was horizontally dipped in a perfluorocarbonsulfonic acid solution having the same concentration as in Example 1 to impregnate the cathode catalyst layer with perfluorocarbonsulfonic acid and then pulled up from the solution, followed by drying. Then, the cathode catalyst layer was peeled from the base material to produce a catalyst layer. The distribution of the proton conductive resin in the direction of thickness was formed in such a condition that the proton conductive resin was contained much in one surface of the cathode catalyst layer by the impregnation and drying processes.

Porous carbon paper used as a cathode gas-diffusing layer was disposed on the surface of the cathode catalyst layer produced in this manner which surface was more increased in the content of the proton conductive resin. The same proton conductive membrane as that explained in Example 1 was disposed on the surface of the cathode catalyst layer which surface was more reduced in the content of the proton conductive resin. An anode produced in the same manner as in Example 1 was disposed on the surface of this proton conductive membrane. The resulting product was subjected to hot pressing to obtain a membrane electrode assembly (MEA).

A direct methanol fuel cell was fabricated in the same manner as in Example 1 except that the obtained membrane electrode assembly was used.

The load current density and output density of this fuel cell were measured in the same manner as above, to find that the cell voltage was lower than that in Comparative Example 1 in all range of load current density. Also, a reduction in output density with time was larger than that in Comparative Example 1.

The present invention is not limited to the aforementioned embodiments and the structural elements may be modified and embodied within the spirit of the invention in its practical stage. Appropriate combinations of plural structural elements disclosed in the above embodiments enable the production of various inventions. For example, several structural elements may be deleted from all the structural elements shown in the embodiments. Also, the structural elements disclosed in different embodiments may be adequately combined.

1. A fuel cell comprising:
a cathode catalyst layer containing a cathode catalyst particle and a proton conductive resin;
an anode catalyst layer; and
a proton conductive membrane provided between the cathode catalyst layer and the anode catalyst layer,
wherein a content of the cathode catalyst particle in the cathode catalyst layer is substantially the same on a first surface facing the proton conductive membrane and on a second surface opposite to the first surface, and
a content of the proton conductive resin in the cathode catalyst layer is increased with an increase in distance from the second surface toward the first surface.

2. The fuel cell according to claim 1, further comprising:
gasified fuel supply means which supplies a gasified component of liquid fuel to the anode catalyst layer; and
an air opening which introduces air to be supplied to the cathode catalyst layer.

3. The fuel cell according to claim 1, wherein the liquid fuel is a pure methanol or an aqueous methanol solution having a concentration exceeding 50 mol %.

4. The fuel cell according to claim 1, further comprising a moisture retentive plate which limits evaporation of water generated in the cathode catalyst layer.

5. The fuel cell according to claim 1, wherein the proton conductive resin contains at least one type selected from the group consisting of a fluororesin having a sulfonic acid group, a hydrocarbon-based resin having a sulfonic acid group and a styrenesulfonic acid polymer.

6. The fuel cell according to claim 1, wherein the proton conductive resin is a perfluorocarbonsulfonic acid.

7. The fuel cell according to claim 1, wherein the cathode catalyst contains a platinum group element.
